(19) United States
(12) Patent Application Publication
(10) Pub. No.: US 2013/0091672 A1
(43) Pub. Date: Apr. 18, 2013

(54) Seat Belt Locking Mechanism Activation System

(71) Applicant: Jason Edwards, Forest Hill, MD (US)

(72) Inventor: Jason Edwards, Forest Hill, MD (US)

(21) Appl. No.: 13/651,022

(22) Filed: Oct. 12, 2012

Related U.S. Application Data
(60) Provisional application No. 61/546,363, filed on Oct. 12, 2011.

(51) Int. Cl. B60R 22/48; A44B 11/25

(52) U.S. Cl. 24/633

(57) ABSTRACT

A seat belt locking mechanism activation system includes a male seat belt buckle portion arranged as a base plate having a first edge, a second edge perpendicular to the first edge, and a plane defined by the first edge and the second edge. The base plate also includes a leading edge measuring about at least 6 millimeters. A void configured to attach into a female seat belt buckle portion is disposed in the plane. A hole is also disposed in the plane. The hole is configured to attach to a keychain.

### CROSS-REFERENCE TO RELATED APPLICATIONS

The present application is a continuation of co-pending U.S. Provisional Patent Application Ser. No. 61/546,363 filed Oct. 12, 2011. The entire disclosure of that application is incorporated herein by reference.

### FIELD OF THE INVENTION

The present invention is directed to seat belts for vehicles.

### BACKGROUND OF THE INVENTION

Seat belts in vehicles are constructed as two, three or five point harnesses that use flexible straps to secure the passenger in a seat. In order for a passenger to secure or to remove the seat belt, one or more buckles are provided. These buckles, located along the length of the flexible straps or secured to the seat or seat frame, are arranged in pairs that provide for attachment and release of the seat belt. The seat belt buckle pairs include a female seat belt buckle portion and a male seat belt buckle portion. The male seat belt buckle portion fits within the female seat belt buckle portion, and a releasable locking mechanism is provided between the female and male seat belt buckle portions. Placing the male seat belt buckle portion in the female seat belt buckle portion activates the locking mechanism, which may be selectively deactivated or released by the passenger.

Also provided within the vehicles are mechanisms that detect the presence of passengers in a given seat location, in particular a front seat location, that detect the activation of the locking mechanism and that provide visual and audible alarms when the locking mechanism is not activated while a passenger is detected in a given seat location and the car ignition is activated. Often, the audible alarm sounds when the seat is occupied by an object other than a passenger, for example, groceries, a briefcase or a heavy tool. In addition, the alarm will sound when the ignition is activated and a passenger is sitting in a given seat but the car is stationary such as when a vehicle has pulled to the side of the road or a mechanic is working on a car. The alarm is annoying and distracting to the occupant, and the only method to stop the alarm is to put on the seat belt or to place the male seat belt buckle portion in the female seat belt buckle portion with the strap behind the seat occupant. These solutions, however, are not always practical or comfortable to the seat passenger, especially a passenger that needs to move around within the seat or that needs to repeatedly get into and out of the seat. Therefore, a mechanism is desired that can activate the locking mechanism to disable the associated alarms without requiring actual engagement of the male seat belt buckle portion in the female seat belt buckle portion.

### SUMMARY OF THE INVENTION

Exemplary embodiments of a seat belt buckle locking mechanism activation system in accordance with the present invention utilize a separate and independent substitute male seat belt buckle portion that is compatible with existing female seat belt buckle portions and that is configured to activate the existing locking mechanism to terminate a seat belt alarm. A male seat belt buckle portion includes a base plate. Suitable materials for the base plate include, but are not limited to plastic and metal. A void is disposed at least partially in the base plate. The void is configured to attach into a female seat belt buckle portion opening of a female seat belt buckle portion. In one embodiment, the void is rectangular. In another embodiment, a hole is also provided. In yet another embodiment, the hole is disposed at least partially in the base plate. The hole is configured to attach to a keychain. In one embodiment, an extension portion is provided. In another embodiment, the extension portion is attached to the base plate. In yet another embodiment, the hole is disposed at least partially in the extension portion.

The base plate includes a first edge. In one embodiment, the first edge has a length of about at least 17 millimeters. In another embodiment, the first edge has a length of about at least 85 millimeters. The base plate also includes a second edge. In one embodiment, the second edge is perpendicular to the first edge. In another embodiment, the second edge has a length of about at least 13 millimeters. In yet another embodiment, the second edge has a length of about at least 53 millimeters. The base plate also includes a third edge. In one embodiment, the third edge is perpendicular to the second edge. In another embodiment, the third edge is parallel to the first edge. In yet another embodiment, the third edge has a length of about at least 17 millimeters. In one embodiment, the third edge has a length of about at least 85 millimeters.

In one exemplary embodiment in accordance with the present invention, the base plate includes a fourth edge. In one embodiment, the fourth edge is perpendicular to a plane defined by the first edge and the second edge. In another embodiment, the fourth edge has a length of about at least 2.25 millimeters. In yet another embodiment, the fourth edge has a length of about at least 1 millimeter. In one embodiment, the base plate includes a fifth edge. In another embodiment, the fifth edge is parallel to the second edge and perpendicular to the first edge. Other embodiments in accordance with the present invention include six, seven, eight, or more edges. The base plate also includes a leading edge measuring about at least 6 millimeters. The leading edge is disposed between the void and the second edge of the base plate.

Exemplary embodiments in accordance with the present invention are also directed to a method for terminating a seat belt alarm. In accordance with this method a base plate of a male seat belt buckle portion is associated with a female seat belt buckle portion opening of a female seat belt buckle portion. The base plate is formed from materials including, but not limited to stainless steel, metal, galvanized, fiberglass, aluminum, laminates and plastic. In one embodiment, the base plate is shaped like a triangle, a circle, an oval, a star, a rectangle, a square, a polygon and combinations thereof. In another embodiment, a void is cut into the base plate. In one embodiment, the void is cut to include a first side, a second side, a third side and a fourth side. In another embodiment the void is cut to include a fourth side. In yet another embodiment, the void is shaped like a triangle, a circle, an oval, a star, a rectangle, a square, a polygon and combinations thereof. In one embodiment, the void is cut at least about 6 millimeters from the second edge of the base plate. In another embodiment, the void is cut at least about 4 millimeters from the first edge. In yet another embodiment, the void is cut at least about 4 millimeters from the third edge. The base plate is inserted into the female seat belt buckle portion opening. The void activates a locking mechanism of the female seat belt buckle portion.

In one embodiment, a hole is cut and configured to attach to a keychain. In one embodiment, the hole is shaped like a triangle, a circle, an oval, a star, a rectangle, a square, a polygon and combinations thereof. In another embodiment, the hole is sized to interlock with a standard keychain ring. In yet another embodiment, the hole is cut at least about a millimeter from the fourth edge.

### BRIEF DESCRIPTION OF THE DRAWINGS

A more complete understanding of the invention and many of the attendant advantages thereto will be readily appreciated as the same becomes better understood by reference to the following detailed description when considered in conjunction with the accompanying drawings wherein like reference numerals and symbols designate identical or corresponding parts throughout the several views and wherein:

FIG. 1 is a schematic representation of an embodiment of a male seat belt buckle portion in accordance with the present invention;

FIG. 2 is a schematic representation of another embodiment of the male seat belt buckle portion;

FIG. 3 is a schematic representation of yet another embodiment of the male seat belt buckle portion; and

FIG. 4 is a schematic representation of yet another embodiment of the male seat belt buckle portion.

### DETAILED DESCRIPTION

Exemplary embodiments of a seat belt buckle locking mechanism activation system in accordance with the present invention utilize a separate and independent substitute male seat belt buckle portion that is compatible with existing female seat belt buckle portions and that is configured to activate the existing locking mechanism to terminate a seat belt alarm. In general, seat belt buckles for use in seat belt restraining systems within vehicles including automobiles, trucks, tractors and airplanes, among others, utilize a multi-part buckle that includes at least one male seat belt buckle portion and at least one female seat belt buckle portion. Embodiments of seat belt buckles exist, however, that use multiple male seat belt buckle portions in a single female seat belt buckle portion. A mating configuration exists between the male seat belt buckle portion and the female seat belt buckle portion.

To secure the male seat belt buckle portion in the female seat belt buckle portion, the seat belt buckle includes a locking mechanism between the male seat belt buckle portion and the female seat belt buckle portion. The locking mechanism is activated upon insertion of the male seat belt buckle portion into the female seat belt buckle portion and is configured to hold and to retain the male seat belt buckle portion in the female seat belt buckle portion until the locking mechanism is selectively inactivated or released.

In general, the locking mechanism includes one or more spring loaded and spring biased members or tangs located within the female seat belt buckle portion and mating slots or voids located on the male seat belt buckle portion. The male seat belt buckle portion, upon insertion of the male seat belt buckle portion into the female seat belt buckle portion, engages a trigger within the female seat belt buckle portion causing the tangs to extend into the voids under the force of the associated biasing members and springs. The tangs are also in communication with buttons or levers located on the outside of the female seat belt buckle portion. When pushed or moved, these buttons or levers move the tangs from the holes and permit the male seat belt buckle portion to be removed. The buttons and levers also reset the trigger within the female seat belt buckle portion. The size and dimensions of the male seat belt buckle portion and the female seat belt buckle portion as well as the associated tangs and voids vary depending on the type of vehicle. Although the general arrangement is the same, there is variability among the male seat belt buckle portions and the female seat belt buckle portions associated with different makes and models of automobiles. The male seat belt buckle portion of one automobile model may not be compatible with the female seat belt buckle portion of another model.

The seat belt buckle locking mechanism activation system of the present invention provides a substitute for existing male seat belt buckle portions that is compatible across various types and configurations of female seat belt buckle portions. The substitute male seat belt buckle portion is configure to have the size and shape required to fit within a plurality of different female seat belt buckle portions, to engage the locking mechanism trigger within the female seat belt buckle portion, therefore activating the locking mechanism, and to engage the tang or other structures within the female seat belt buckle portion to secure the substitute male seat belt buckle portion within the female seat belt buckle portion while the locking mechanism is engaged. The substitute male seat belt buckle portion is released from the female seat belt buckle portion when the existing external button is pressed and extends a sufficient distance from the female seat belt buckle portion to facilitate grabbing the substitute male seat belt buckle portion and removing it from the female seat belt buckle portion.

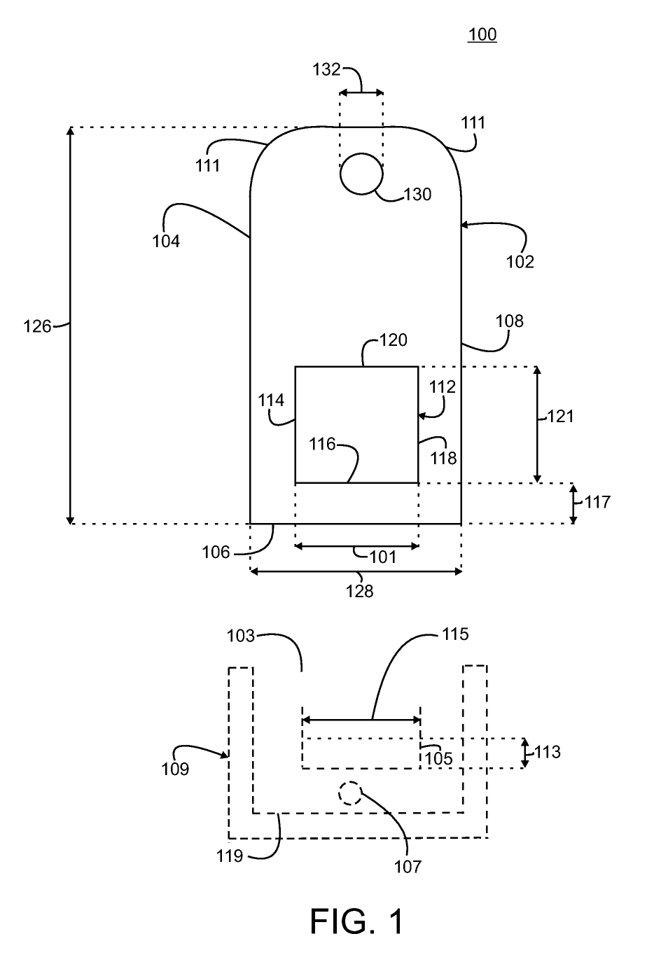

Referring initially to FIG. 1, an exemplary embodiment of seat belt buckle locking mechanism activation system 100 in accordance with the present invention is illustrated. The seat belt buckle locking mechanism activation system is configured as a substitute male seat belt buckle portion 102. In one embodiment, the substitute male seat belt buckle portion 102 is arranged as a flat plate or base plate having four edges, a leading edge 106, a pair of side edges 104, 108 extending back from the leading edge 106, and a trailing edge 110 extending between the side edges opposite the leading edge. Suitable materials for the base plate include, but are not limited to, metals such as galvanized steel, stainless steel or aluminum, fiberglass, polymers or plastics and combinations thereof including laminates. As illustrated, the base plate is generally rectangular in shape. However, other suitable shapes for the base plate include, but are not limited to triangular, circular, oval, square and polygonal.

The substitute male seat belt buckle portion also includes a locking engagement edge 116. In one embodiment, the locking engagement edge 116 is configured parallel to the leading edge 106 and spaced back from the leading edge a predetermined distance 117. The leading edge has a width 128 selected to allow the substitute male seat belt buckle portion 102 to be inserted into the channel 103 of a female seat belt buckle portion 109. This width 128 is selected to accommodate a plurality of different female seat belt buckle portions across different types and models of automobiles and vehicles. Therefore, the seat belt buckle locking mechanism activation system of the present invention functions as a universal seat belt buckle locking mechanism activation system. In one embodiment, the leading edge 106 has a length of from about 12 millimeters to about 21 millimeters. In one embodiment, the leading edge 106 has a length of about 13 millimeters. In another embodiment, the leading edge has a length of about 21 millimeters.

The predetermined distance 117 between the leading edge 106 and the engagement edge 116 is selected so that the leading edge extends a sufficient distance into the female seat belt buckle portion to engage any locking mechanism triggers 107, and the engagement edge 116 is spaced a sufficient distance back from the leading edge 106 to engage the biased tang 105 or tangs within the female seat belt buckle portion that are released when the leading edge engages the trigger. Therefore, the substitute male seat belt buckle portion activates the locking mechanism and is secured in the female seat belt buckle portion by the locking engagement between the tang and the engagement edge. The predetermined distance 117 is preferably selected to function with a plurality of different female seat belt buckle portions across different types and models of automobiles and vehicles. In one embodiment, the predetermined distance is from about 4 millimeters to about 7 millimeters. For example, the predetermined distance 117 is about 6 millimeters.

As illustrated, the trigger 107 for the locking mechanism in the female seat belt buckle portion is located in the channel 103 past the tang 105. In general, the trigger 107 is located between the tang 105 and the end 119 of the channel, and the substitute male seat belt buckle portion 102 including the leading edge 106 and the engagement edge 116 is configured to accommodate the location and configuration of tangs and triggers in a plurality of different female seat belt buckle portions across different types and models of automobiles and vehicles. The trigger is in communication with the tang, which is in communication with audible and visual alarms. When the tang is released and engages the engagement edge, the alarm stops. A release mechanism (not shown) also in communication with the tang, disengages the tang from the engagement edge, allowing the substitute male seat belt buckle portion to be withdrawn from the channel of the female seat belt buckle portion. Suitable release mechanisms are known in the art and include, but are not limited to, latches, levers, knobs and buttons.

The substitute male seat belt buckle portion is formed as a generally flat sheet or plate having a thickness of from about 2 millimeters to about 5 millimeters, preferably about 3 millimeters. In one embodiment, the plate has a thickness of from about 1 millimeter to about 2.25 millimeters. In one embodiment, in order to accommodate the width 115 and depth 113 of the tang 105 in the female seat belt buckle portion, the engagement edge 106 is formed as part of a void 112 formed in the flat plate that passes completely through the thickness of the plate. Suitable shapes for the void include, but are not limited to, triangles, circles, ovals, stars, rectangles, squares, polygons and combinations thereof. In one embodiment, the void includes one or more curved sides.

As illustrated, the void is shaped as a rectangular or square hole passing through the thickness of the plate. The void is defined by the engagement edge 116, a pair of sides 114, 118 extending back from the engagement edge and a back or fourth side 120 extending between the pair of sides opposite the engagement edge. The pair of sides is spaced sufficiently apart to define a length 101 for the engagement edge that is sufficient to accommodate the width 115 of the tang 105. In one embodiment, the engagement edge 116 has a length 101 of from about 12 millimeters to about 21 millimeters. In one embodiment, the length 101 is about 13 millimeters. In another embodiment, the length 101 is about 21 millimeters.

In addition, the pair of opposing sides has a length 121 sufficient to accommodate the depth 113 of the tang 105 between the engagement edge 116 and the back side edge 120. A suitable length 121 for the side is from about 9 millimeters to about 20 millimeters. In one embodiment, the length 121 is about 17 millimeters. In general, the void has an overall area that is sufficient to accommodate the area of the tang.

As was discussed above, the substitute male seat belt buckle portion 102 is arranged as a flat plate or base plate having four edges, a leading edge 106, a pair of side edges 104, 108 extending back from the leading edge 106, and a trailing edge 110 extending between the side edges opposite the leading edge. The pair of side edges each has a length 126 that is selected so that the substitute male seat belt buckle portion extends outside the channel 103 in the female seat belt buckle portion after the substitute male seat belt buckle portion has been inserted into the channel and the locking mechanism has been engaged. This length is sufficient to allow an occupant to grasp the substitute male seat belt buckle portion while it is disposed within the female seat belt buckle portion. In one embodiment, each side edge 104, 108 has a length 126 of from about 17 millimeters to about 52 millimeters. In one embodiment, the length 126 is about 17 millimeters.

The trailing edge 110 in one embodiment is parallel to the leading edge 106 and has a range of lengths equivalent to the leading edge. In addition, the trailing edge can be lengthened or shaped to create a larger area in the substitute male seat belt buckle portion for grasping. Although all of the edges or sides of the base plate and void can meet at sharp angles or right angles, the transitions between edges or sides can also be rounded or radiused. For example, the substitute male seat belt buckle portion can include rounded corners 111 between the side edges 104, 108 and the trailing edge 110.

In one embodiment, the substitute male seat belt buckle portion includes a hole 130 passing completely through the thickness of the plate. The hole is configured to provide for the attachment of a tethering device such as a lanyard or keychain. In one embodiment, a plurality of holes is provided. Suitable shapes for the hole include, but are not limited to triangles, circles, ovals, stars, rectangles, squares, polygons and combinations thereof. Preferably, the hole is circular and has a diameter 132 of from about 1 millimeter to about 5 millimeters. In one embodiment, the diameter is about 3 millimeters.

In one embodiment, the hole is large enough and spaced an appropriate distance from the trailing edge or side edges to interlock with a standard keychain ring. In one embodiment, the hole is located at least about 1 millimeter to about 3 millimeters from each of the side edges and at least about 1 millimeter to about 3 millimeters from the trailing edge 110

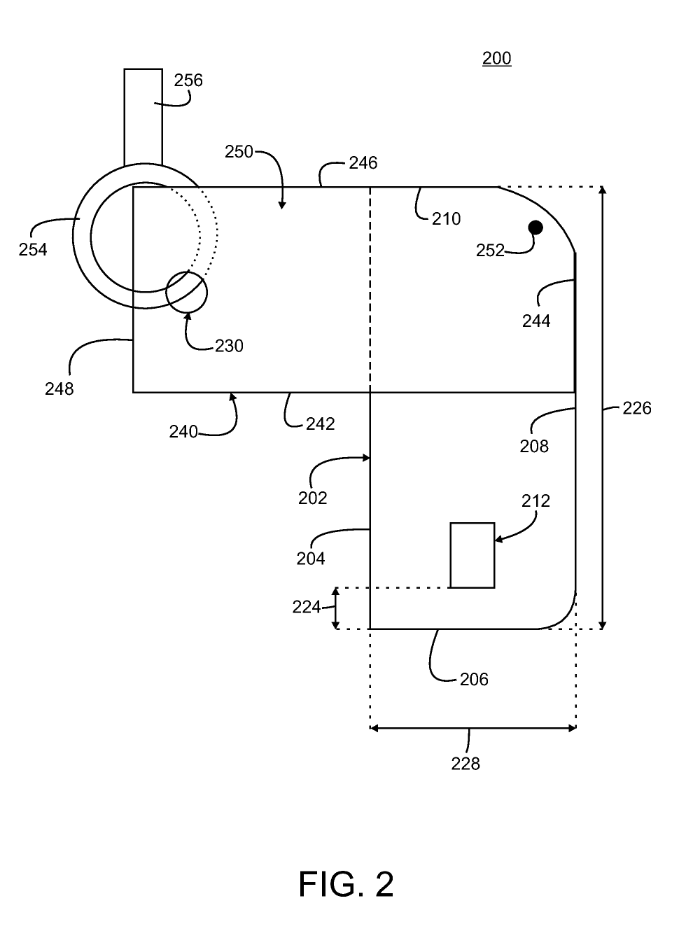

Referring to FIG. 2, another exemplary embodiment of the substitute male seat belt buckle portion 200 in accordance with the present invention is illustrated. In this embodiment, the substitute male seat belt buckle portion includes a base plate 202. Disposed within the base plate is a void 212 configured to accommodate the tang within a female seat belt buckle portion. In one embodiment, a plurality of voids is provided. The base plate also includes a first edge 204, a second edge 206 and a third edge 208. The first edge 204 of the base plate in one embodiment has a length of about at least 17 millimeters. In another embodiment, the first edge 204 has a length in the range of about 17 millimeters to about 52 millimeters. In one embodiment, the length of the first edge 204 contributes to an overall length or height 226 of the base plate. This height 226 is selected to be sufficient such that the base plate 202 when inserted into a female seat belt buckle portion is disposed only partially within the female seat belt buckle portion. In one embodiment, the height is sufficient to allow an occupant to grasp the base plate while it is disposed within the female seat belt buckle portion.

In one embodiment, the second edge 206 of the base plate has a length of at least about 13 millimeters. In another embodiment, the second edge 206 has a length in the range of about 13 millimeters to about 21 millimeters. In one embodiment, the second edge 206 extends perpendicular to the first edge 204. The second edge has a width 228 that is selected to accommodate the length of a span of an opening of the female seat belt buckle portion. In one embodiment, the width 228 is from about 13 millimeters to about 21 millimeters. Preferably, the width 228 is at least about 13 millimeters.

In one embodiment, the third edge 208 of the base plate has a length of from about 17 millimeters to about 52 millimeters. In one embodiment, the third edge has a length of at least about 17 millimeters. In one embodiment, the third edge 208 extends perpendicular to the second edge 206 and is parallel to the first edge 204. In one embodiment, the base plate includes a fourth edge 210. Preferably the fourth edge 210 extends perpendicular to the first edge 204 and parallel to the second edge 206. In one embodiment, the fourth edge has a length of from about 13 millimeters to about 21 millimeters. In one embodiment, the fourth edge has a length of at least about 13 millimeters.

The void 212 is spaced a predetermined distance 224 from the second edge 206 of the base plate 102. The distance 224 is preferably about 6 millimeters. In one embodiment, the distance 224 is from about 4 millimeters to about 7 millimeters.

In one embodiment, the substitute male seat belt buckle portion includes an extension portion 240. In one embodiment, the extension portion 240 is attached to the base plate 202 with an attachment mechanism 252. Suitable attachment mechanisms include, but are not limited to fasteners such as bolts, screws, hooks, magnets, adhesives, and clamps. The extension portion can be constructed from a variety of materials including, but not limited to, metals such as galvanized steel, stainless steel or aluminum, fiberglass, polymers or plastics and combinations thereof including laminates. Suitable shapes for the extension portion include, but are not limited to triangles, circles, ovals, stars, rectangles, squares, polygons and combinations thereof. In one embodiment, the extension portion includes one or more curved sides. The extension portion 240 rotates with respect to the base plate 202 about an axis associated with the attachment mechanism 252.

The extension portion 240 also includes a first face 242. In one embodiment, the first face 242 has a length of at least about 17 millimeters. In another embodiment, the first face 242 has a length in the range of about 17 millimeters to about 80 millimeters. The extension portion also includes a second face 244. In one embodiment, the second face has a length of at least about 13 millimeters. In another embodiment, the second face 244 has a length in the range of about 13 millimeters to about 80 millimeters. In one embodiment, the second face 244 extends perpendicular to the first face 242. The extension portion also includes a third face 246. In one embodiment, the third face 246 has a length of at least about 17 millimeters. In another embodiment, the third face 246 has a length in the range of about 17 millimeters to about 80 millimeters. In one embodiment, the third face 246 extends perpendicular to the second face 244 and parallel to the first face 242.

In one embodiment, the first face 242 and the second face 244 define a surface 250 in the extension portion 240. In one embodiment, the extension portion 240 also includes a fourth face 248. Preferably the fourth 248 face is perpendicular to the first face 242. In one embodiment, the fourth face has a length of at least about 13 millimeters. In another embodiment, the fourth face 248 has a length in the range of about 13 millimeters to about 80 millimeters. In one embodiment, the extension portion includes a fifth face. Preferably, the fifth face is perpendicular to the surface 250 and defines a thickness of the extension portion. Other embodiments in accordance with the present invention include six, seven, eight, or more faces. In one exemplary embodiment, the base plate 202 folds out from the extension portion 240. In another embodiment, other components fold out from the extension portion. Suitable components include, but are not limited to a blade, tweezers, a toothpick, a corkscrew, a can opener, a bottle opener, a screwdriver, a nail file, scissors, a saw, a file, a hook, a magnifying glass, a pen, a fish scaler, a wrench, pliers, a USB flash drive, a digital clock, an altimeter, an LED light, a laser pointer, a music player, a compass, a tire pressure gauge and a hammer configured to shatter a windshield.

In one exemplary embodiment, a hole 230 is also provided in at least one of the base plate or the extension portion. Preferably the hole 230 passes completely through the extension portion 240. In one embodiment, the hole is located at least about 1 millimeter from the fourth face 248 of the extension portion 240. In another embodiment, the hole 230 is located at least about 4 millimeters from the first face 242 of the extension portion. In yet another embodiment, the hole is located at least about 4 millimeters from the third face 246 of the extension portion. In one exemplary embodiment, the hole is disposed between the void 212 and the second face 244 of the extension portion 240.

In one embodiment, the hole 230 is attached to a keychain attachment mechanism 254. Suitable keychain attachment mechanisms include, but are not limited to rings. In another embodiment, the keychain attachment mechanism is attached to a keychain release mechanism 256. Suitable keychain release mechanisms include, but are not limited to pins, screws, and clasps.

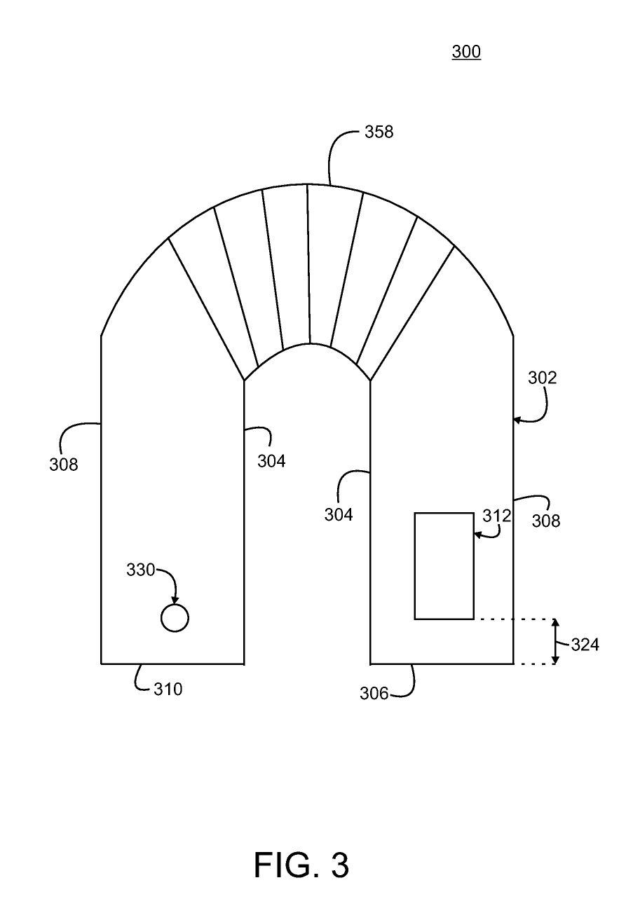

Referring to FIG. 3, another exemplary embodiment of a substitute male seat belt buckle portion 300 in accordance with the present invention is illustrated. In this embodiment, the substitute male seat belt buckle portion is arranged as a base plate 302. A void 312 is disposed within the base plate. In one embodiment, the substitute male seat belt buckle portion includes a plurality of voids. The base plate also includes a first edge 304, a second edge 306 and a third edge 308. In one embodiment, the first edge 304 has a length in the range of about 21 millimeters to about 100 millimeters. In one embodiment, the second edge 306 has a length in the range of about 13 millimeters to about 21 millimeters. In one embodiment, the third edge 308 has a length in the range of about 21 millimeters to about 100 millimeters.

The void 312 is spaced from the second edge 306 of the base plate 302 by a predetermined distance 324. The distance 324 is preferably about 6 millimeters. In one embodiment, the distance 324 is in the range of about 4 millimeters to about 7 millimeters.

In one embodiment, the base plate 302 includes a bending portion or bending mechanism 358. The bending mechanism can be constructed from a variety of materials including, but not limited to metals, laminates, plastic, rubber and combinations thereof. In one exemplary embodiment, the bending mechanism is used to bend the base plate into a U shape.

In one embodiment, the base plate 302 includes a hole 330 passing completely through the base plate 302. The hole is configured to attach to a keychain, lanyard or other tethering device. In one embodiment, the hole is located at least about 1 millimeter from the fourth edge 310 of the base plate 302, at least about 4 millimeters from the first edge 304 of the base plate and at least about 4 millimeters from the third edge 308 of the base plate. In one exemplary embodiment, the hole is disposed between the void 312 and the second edge 306 or the fourth edge 310.

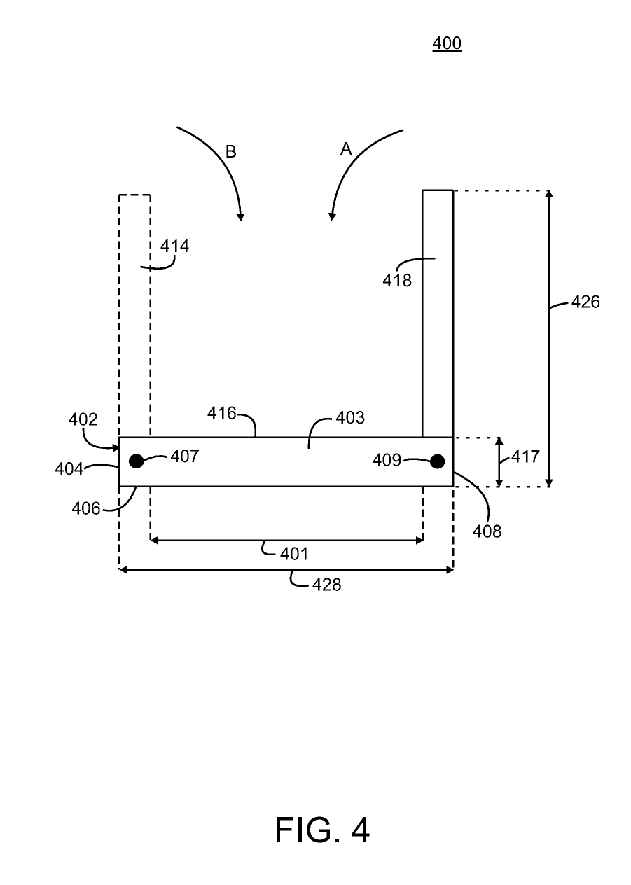

Referring to FIG. 4, another embodiment of a substitute male seat belt buckle portion 400 in accordance with the present invention is illustrated. In this embodiment, the substitute male seat belt buckle portion is arranged as either a fixed or foldable “L” or “U” shaped device that has a thickness between the leading edge and engagement edge sufficient to trigger the locking mechanism in the female seat belt buckle portion to deactivate the audible and visual alarms and to engage the tang to hold the substitute male seat belt buckle portion in the female seat belt buckle portion and an overall length sufficient to extend from the female seat belt buckle portion upon activation of the locking mechanism.

As illustrated, the substitute male seat belt buckle portion 402 is arranged as a flat plate or base plate having a first member 403 arranged as generally a rectangular member having four edges including a leading edge 406, a pair of side edges 404, 408 extending back from the leading edge 406, and an engagement edge 416 extending between the side edges opposite the leading edge. Suitable materials for the base plate include, but are not limited to, metals such as galvanized steel, stainless steel or aluminum, fiberglass, polymers or plastics and combinations thereof including laminates. As illustrated, the base plate is generally rectangular in shape. However, other suitable shapes for the base plate include, but are not limited to triangular, circular, oval, square and polygonal as long as these shapes have the leading edge and engagement edge as described herein.

In one embodiment, the locking engagement edge 416 is configured parallel to the leading edge 406 and spaced back from the leading edge a predetermined distance 417. The leading edge has a width 428 selected to allow the substitute male seat belt buckle portion 402 to be inserted into the channel of a female seat belt buckle portion. This width 428 is selected to accommodate a plurality of different female seat belt buckle portions across different types and models of automobiles and vehicles. Therefore, the seat belt buckle locking mechanism activation system of the present invention functions as a universal seat belt buckle locking mechanism activation system. In one embodiment, the leading edge 406 has a length of from about 12 millimeters to about 21 millimeters. In one embodiment, the leading edge 406 has length of about 13 millimeters. In another embodiment, the leading edge has a length of about 21 millimeters.

The predetermined distance 417 between the leading edge 406 and the engagement edge 416 is selected so that the leading edge extends a sufficient distance into the female seat belt buckle portion to engage any locking mechanism triggers and the engagement edge 416 is spaced a sufficient distance back from the leading edge 406 to engage the biased tang or tangs within the female seat belt buckle portion that are released when the leading edge engages the trigger. Therefore, the substitute male seat belt buckle portion activates the locking mechanism and is secured in the female seat belt buckle portion by the locking engagement between the tang and the engagement edge. The predetermined distance 417 is preferably selected to function with a plurality of different female seat belt buckle portions across different types and models of automobiles and vehicles. In one embodiment, the predetermined distance is from about 4 millimeters to about 7 millimeters. For example, the predetermined distance 417 is about 6 millimeters.

The substitute male seat belt buckle portion 402 including the leading edge 406 and the engagement edge 416 is configured to accommodate the location and configuration of tangs and triggers in a plurality of different female seat belt buckle portions across different types and models of automobiles and vehicles. The trigger is in communication with the tang, which is in communication with audible and visual alarms. When the tang is released and engages the engagement edge, the alarm stops. A release mechanism also in communication with the tang disengages the tang from the engagement edge, allowing the substitute male seat belt buckle portion to be withdrawn from the channel of the female seat belt buckle portion. Suitable release mechanisms are known in the art and include, but are not limited to, latches, levers, knobs and buttons.

The substitute male seat belt buckle portion includes a second member 418 extending back from the first member 403. In one embodiment, the first member and the second member form an “L” shape. The first and second members can be fixed in the “L” shape. For example, the first and second members can be formed or stamped from a single sheet of material. Suitable materials for the second member are the same as for the first member. Alternatively, the first and second members are separate members, and the second member pivots with respect to the first member in the direction of arrow A about a first axis pin 409. The second member can be rotated until it is aligned with the first member or moves into a slot within the first member. In this embodiment, the substitute male seat belt buckle portion is configured like a folding pocket knife to facilitate transport and storage of the substitute male seat belt buckle portion. When completely opened to the “L” shape, the second member is preferably locked into position using releasable locking mechanisms.

In one embodiment, the second member has a length 426 that is selected so that the substitute male seat belt buckle portion extends outside the channel in the female seat belt buckle portion after the substitute male seat belt buckle portion has been inserted into the channel and the locking mechanism has been engaged. This length is sufficient to allow an occupant to grasp the substitute male seat belt buckle portion while it is disposed within the female seat belt buckle portion. In one embodiment, the length 426 is from about 17 millimeters to about 52 millimeters. In one embodiment, the length 426 is about 17 millimeters.

In one embodiment, the substitute male seat belt buckle portion includes a third member 414 extending back from the first member 403. In one embodiment, the first member, the second member and the third member form a “U” shape. The first, second and third members can be fixed in the “U” shape. For example, the first, second and third members can be formed or stamped from a single sheet of material. Suitable materials for the third member are the same as for the first member. Alternatively, the first, second and third members are separate members, and the third member pivots with respect to the first member in the direction of arrow B about a second axis pin 409. The third member can be rotated until it is aligned with the first and second members or moves into a slot within the first member. In this embodiment, the substitute male seat belt buckle portion is configured like a folding pocket knife to facilitate transport and storage of the substitute male seat belt buckle portion. When completely opened to the “U” shape, the second member and third member are preferably locked into position using releasable locking mechanisms.

In one embodiment, the third member has a length 426 that is selected so that the substitute male seat belt buckle portion extends outside the channel in the female seat belt buckle portion after the substitute male seat belt buckle portion has been inserted into the channel and the locking mechanism has been engaged. This length is sufficient to allow an occupant to grasp the substitute male seat belt buckle portion while it is disposed within the female seat belt buckle portion. In one embodiment, the length 426 is from about 17 millimeters to about 52 millimeters. In one embodiment, the length 426 is about 17 millimeters.

All of the members of the substitute male seat belt buckle portion are formed as generally flat sheets or plates having a thickness of from about 2 millimeters to about 5 millimeters, preferably about 3 millimeters. In one embodiment, the plate has a thickness of from about 1 millimeter to about 2.25 millimeters.

In one embodiment, in order to accommodate the width of the tang in the female seat belt buckle portion, the engagement edge has a length 401 not covered by the second member or located between the second member and third member that is sufficient to accommodate the tang width. In one embodiment, this engagement edge 416 length 401 is from about 12 millimeters to about 21 millimeters. In one embodiment, the length 401 is about 13 millimeters. In another embodiment, the length 401 is about 21 millimeters. As either the “L” shaped configuration or “U” shaped configuration defines an opening channel, any depth of tang is accommodated.

In one embodiment, any one of the members of the substitute male seat belt buckle portion can include holes or loops to provide for the attachment of a tethering device such as a lanyard or keychain.

Exemplary embodiments in accordance with the present invention are also directed to a method for terminating a seat belt alarm. In accordance with this method a base plate of a male seat belt buckle portion is associated with a female seat belt buckle portion opening of a female seat belt buckle portion. The base plate is formed from materials including, but not limited to stainless steel, metal, galvanized, fiberglass, aluminum, laminates and plastic. In one embodiment, the base plate is shaped like a triangle, a circle, an oval, a star, a rectangle, a square, a polygon and combinations thereof. In another embodiment, a void is cut into the base plate. In one embodiment, the void is cut to include a first side, a second side, a third side and a fourth side. In another embodiment the void is cut to include a fourth side. In yet another embodiment, the void is shaped like a triangle, a circle, an oval, a star, a rectangle, a square, a polygon and combinations thereof. In one embodiment, the void is cut at least about 6 millimeters from the second edge of the base plate. In another embodiment, the void is cut at least about 4 millimeters from the first edge. In yet another embodiment, the void is cut at least about 4 millimeters from the third edge. The base plate is inserted into the female seat belt buckle portion opening. The void activates a locking mechanism of the female seat belt buckle portion.

In one embodiment, a hole is cut and configured to attach to a keychain. In one embodiment, the hole is shaped like a triangle, a circle, an oval, a star, a rectangle, a square, a polygon and combinations thereof. In another embodiment, the hole is sized to interlock with a standard keychain ring. In yet another embodiment, the hole is cut at least about a millimeter from the fourth edge.

It will be understood that many additional changes in details, materials, steps, and arrangements of parts which have been described herein and illustrated in order to explain the nature of the invention, may be made by those skilled in the art within the principle and scope of the invention as expressed in the appended claims.

What is claimed is:

1. A seat belt buckle locking mechanism activation system comprising:
a substitute male seat belt buckle portion comprising:
a leading edge configured to fit within a channel of a female seat belt buckle portion;
an engagement edge running parallel to the leading edge and spaced a sufficient distance from the leading edge such that the leading edge engages a trigger mechanism that activates a seat belt buckle locking mechanism and the engagement edge engages a spring biased tang within the female seat belt buckle portion to hold the substitute male seat belt buckle portion within the female seat belt buckle portion; and
an overall length extending back from the leading edge that is greater that a depth of the channel of the female seat belt buckle portion such that at least a portion of the substitute male seat belt buckle portion extends from the female seat belt buckle portion upon activation of the locking mechanism;
wherein activation of the locking mechanism deactivates alarms associated with the seat belt buckle.
